(19) United States
(12) Patent Application Publication
(10) Pub. No.: US 2011/0051626 A1
(43) Pub. Date: Mar. 3, 2011

(54) SYSTEM AND METHOD FOR WIRELESS NODE CONNECTION

(75) Inventors: TENG TAI HSU, Taipei (TW); CHIEN-HUA CHEN, Taipei (TW); WEI-YAO CHOU, Taipei (TW)

(73) Assignee: 4IPNET, INC., Taipei (TW)

(21) Appl. No.: 12/861,849

(22) Filed: Aug. 24, 2010

(30) Foreign Application Priority Data
Aug. 28, 2009 (TW) 098129018

(51) Int. Cl. H04L 12/28; H04W 4/00

(52) U.S. Cl. 370/255

(57) ABSTRACT

Systems and methods for wireless node connection are provided. The system includes a first wireless node and a second wireless node connected to a network. The first wireless node transmits a beacon packet with at least one connection parameter corresponding to the first wireless node. The second wireless node receives the beacon packet from the first wireless node, and analyzes the beacon packet to obtain the connection parameter corresponding to the first wireless node. The second wireless node wirelessly connects to the first wireless node according to the connection parameter. At least one wireless terminal connects to the network via the first wireless node and the second wireless node. Wireless network deployment often requires a wireless node to construct wireless link to another wireless node. Such deployment type is commonly used in point-to-point or point-to-multipoint wireless infrastructure. A push-to-connect algorithm is used to support the automatic wireless connection among multiple wireless nodes. A time synchronization key exchange algorithm is used to enhance the security of any wireless link between two wireless nodes.

### BACKGROUND

1. Field of the Invention

The present invention pertains to a method of automatically building wireless connection among multiple wireless nodes used in wireless communication infrastructure deployment. Specifically, the present invention relates to a system and method of automatic connecting multiple wireless nodes without the need to manually configure each wireless node.

2. Related Art

In wireless network deployment such as deploying multiple 802.11 WLAN network nodes, in the situation of lacking the wired connecting outlets to backend network, it often requires the wireless node at such location to be connected wirelessly to a wireless node that has access to the backend network. The common practice is to configure the two wireless nodes that are to form a wireless connected pair with network parameters such as the peer network node's MAC (Medium Access Control) address, channel used for wireless signal transmission, and wireless link security parameters. The procedures are usually time consuming and often required a separate device (such as a laptop computer or terminal) to configure the wireless nodes. This need of a separate device to configure the wireless node has caused the inconvenience in setting up the configuration environment such as in outdoor environment. Furthermore, the complicated parameters required to be configured correctly to build a secure wireless connection between two wireless nodes be require technical personnel with proficient networking knowledge. This has caused the difficulty in deployment and maintenance of building a large scale wireless network.

What is needed is a system and method of automatic constructing secure wireless connection between among multiple wireless nodes without the need of separate configuration device which provides the robustness in order to deploy a large scale wireless network while meeting the challenges of reducing maintenance complexity of such network deployment.

### SUMMARY

It is an object of the present invention to provide a system and method of automatically establishing secure wireless links among multiple wireless nodes without the need to manually configure each wireless node. The wireless nodes that will establish a wireless link are categorized into two types, “to be connected” and “to connect”, respectively. The mechanism of triggering different types of wireless nodes can be achieved via: pressing a button on the wireless node; issuing a command on the wireless node's command line interface (CLI); and clicking on the icon on the node's configuration interface.

The wireless node that is triggered into the type of “to be connected” performs the following actions:
i. enter the “waiting for connection” state within a configurable time period, wherein the wireless node will resume to its normal state when the configurable time period expires;
ii. continue transmitting the Beacon packet with an IE (Information Element) that indicates its type with parameters to be used for establishing a wireless connection;
iii. process the IE received from a peer wireless node to extract the parameters for establishing a wireless link, wherein the wireless node will discard the IE with the same node type;
iv. transmit the confirmed packet to a peer wireless node to validate the successful connection of a wireless link;
v. exchange the encryption key with a peer wireless node upon validating a successful wireless link, wherein the method of encryption could be WEP, AES, TKIP, etc.; and
vi. change the encryption key based on a pre-configured time stamp to enhance the security level.

The wireless node that is triggered into the type of “to connect” performs in the following actions:
i. enter the “request for connection” state within a configurable time period, wherein the wireless node will resume to its normal state when the configurable time period expires;
ii. continue transmitting the Beacon packet with an IE (Information Element) that indicates its type with parameters to be used for establishing a wireless connection;
iii. process the IE received from a peer wireless node to extract the parameters for establishing a wireless link, wherein the wireless node will discard the IE with the same node type;
iv. transmit the confirmed packet to a peer wireless node to validate the successful connection of a wireless link;
v. exchange the encryption key with a peer wireless node upon validating a successful wireless link, wherein the method of encryption could be WEP, AES, TKIP, etc.; and
vi. change the encryption key based on a pre-configured time stamp to enhance the security level.

The new IE (Information Element) that is added to the Beacon to transmit the descriptive information for automatically establishing a wireless link include the following fields:
i. Element Identifier,
ii. Information Element Length,
iii. Node Type (i.e. “to be connected” or “to connect”),
iv. Encrypted Information that comprises of the wireless node's MAC (Media

Access Control) address encrypted with a pre-defined secret key; the method of encryption could be MDS, SHA-1, SHA-256/224 etc.

### BRIEF DESCRIPTION OF THE DRAWINGS

FIG. 1 is the system diagram of the method for wireless node connection described in this invention;

FIG. 2 is the generalized block diagram of a wireless node implemented with the automatic wireless connection algorithm described in this invention;

FIG. 3 shows a flow diagram illustrating a process for establishing the wireless connection between two wireless nodes;

FIG. 4 shows a flow diagram illustrating an alternative embodiment of the wireless connection process described in this invention;

FIG. 5A is a new IE (Information Element) that is added to the Beacon packet to transmit the descriptive information for establishing wireless link automatically;

FIG. 5B is another IE that is added to the Beacon packet for a wireless node to identify the role of establishing wireless connection described in this invention.

### DETAILED DESCRIPTION

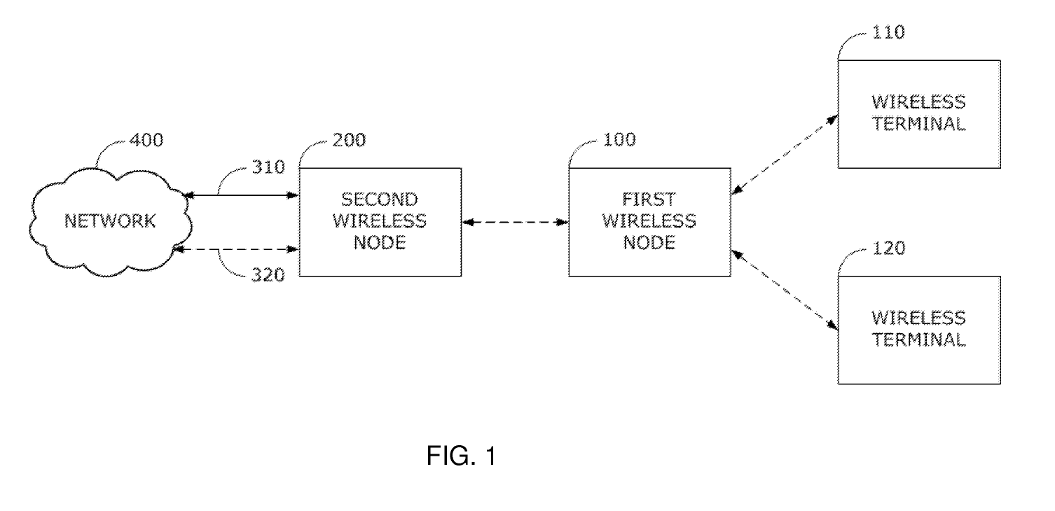

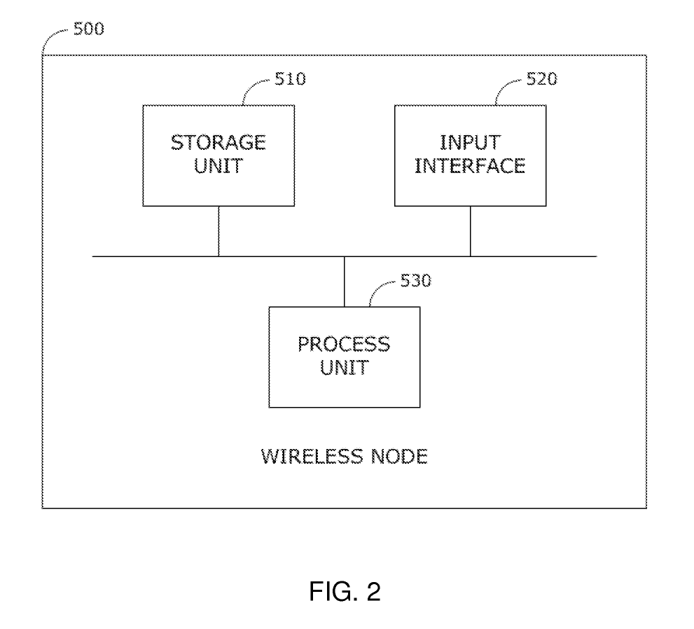

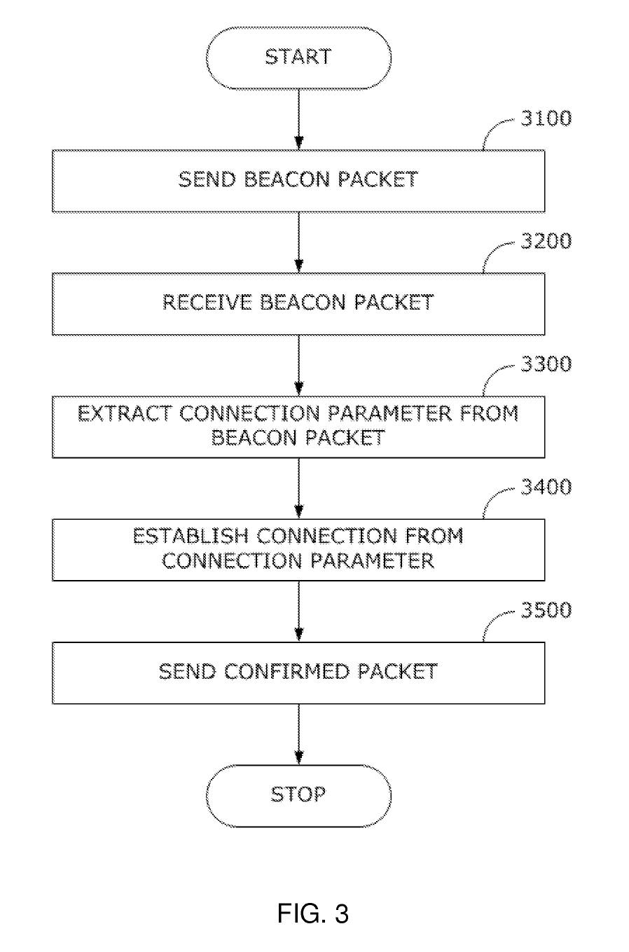

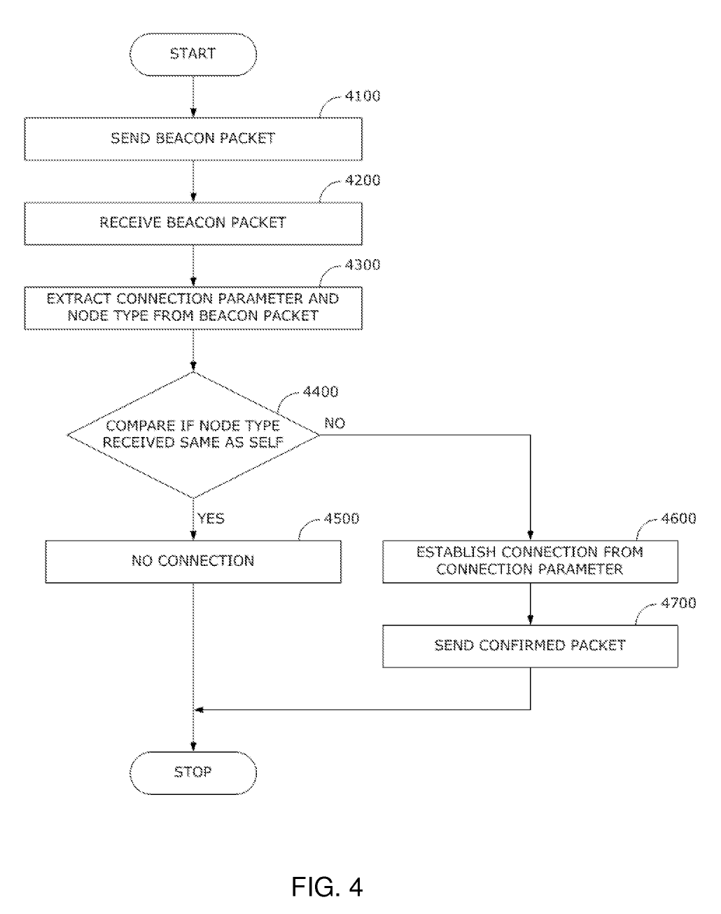

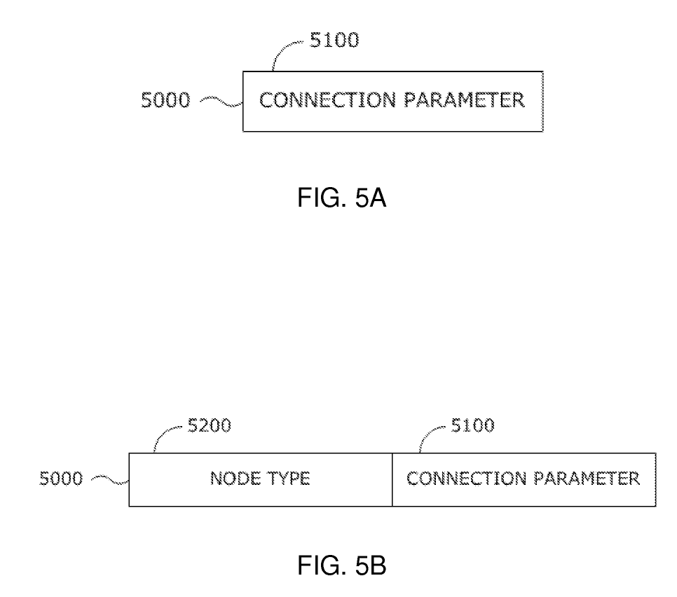

FIG. 1 is a system and method for wireless node connection. The SECOND WIRELESS NDOE 200 is connected to the NETWORK 400 via wired 310 or wireless 320 connection. The FIRST WIRELESS NODE 100 transmits the BEACON PACKET that includes the FIRST WIRELESS NODE's 100 NODE TYPE 5200 and CONNECTION PARAMETER 5100 (FIG. 5A and FIG. 5B). The FIRST WIRELESS NODE 100 and the SECOND WIRELESS NODE 200 establish the wireless connection based on the CONNECTION PARAMETER. Terminals 110 and 120 connect to the NETWORK 400 via the FIRST WIRELESS NODE 100 and the SECOND WIRELESS NODE 200.

The wireless node's NODE TYPE 5200 used for establishing the wireless connection has two types, “to be connected” and “to connect”, respectively. The wireless connection between the FIRST WIRELESS NODE 100 and the SECOND WIRELESS NODE 200 is encrypted to protect the data communicated via this connection. The encryption key is changed continuously and automatically via a pre-defined time stamp in the FIRST WIRELESS NODE 100 and the SECOND WIRELESS NODE 200.

What is claimed is:

1. A wireless node connection system, comprising:
a first wireless node that transmits the BEACON PACKET;
a second wireless node that is connected to another network;
the second wireless node receives and processes the BEACON PACKET, extracting the CONNECTION PARAMETER of the first wireless node and establishes the wireless connection with the first wireless node based on said parameter;
one or more wireless terminals connect to the network via the first wireless node and the second wireless node.

2. The system as recited in claim 1, wherein the first wireless node and the second wireless node are assigned to a NODE TYPE to indicate their roles in establishing a wireless connection between the two nodes. The first wireless node transmits the NODE TYPE and the CONNECTION PARAMETER via a BEACON PACKET to the second wireless node. The second wireless node extracts the NODE TYPE information from the BEACON PACKET sent from the first wireless node. The second wireless node starts establishing the wireless connection with the first wireless node based on the CONNECTION PARAMETER if the received NODE TYPE of the first wireless node is different from that of the second wireless node.

3. The system as recited in claim 2, wherein the second wireless node discards the BEACON PACKET if the NODE TYPE received from the first wireless node is the same as the second wireless node's NODE TYPE.

4. The system as recited in claim 2, wherein an input will assign the first or second wireless node to a NODE TYPE, which could be the type of “to be connected” or “to connect”.

5. The system as recited in claim 4, wherein the input could be entered via:
pressing a button on the first wireless node or the second wireless node;
issuing a command on the CLI (Command Line Interface) of the first or second wireless node; and
clicking on the icon on the configuration interface of the first or second wireless node.

6. The system as recited in claim 4, wherein a wireless node is determined by the time duration of pressing the button. The wireless node is assigned to the type of “to be connected” if said time duration exceeds a pre-defined value, or to the type of “to connect” if said time duration does not exceeds said value.

7. The system as recited in claim 6, wherein a wireless node will maintain its assigned NODE TYPE within a pre-defined period. The wireless node cancels its NODE TYPE if the pre-defined time period is exceeded.

8. The system as recited in claim 1, wherein the CONNECTION PARAMETER includes the wireless node's MAC (Medium Control Access) address.

9. The system as recited in claim 8, wherein the wireless node encrypts the MAC address transmitted in the BEACON PACKET.

10. The system as recited in claim 1, wherein the first wireless node and the second wireless node transmit at least a CONFIRMED PACKET between each other to complete the wireless connection between the two wireless nodes.

11. The system as recited in claim 1, wherein the first wireless node and the second wireless node exchanges at least a encryption key which is used to encrypt the data communicated via the wireless connection between the two wireless nodes.

12. The system as recited in claim 11, wherein the first wireless node and the second wireless node changes the encryption key based on a pre-defined time stamp. The new encryption key is used to encrypt the data communicated via the wireless connection between these two wireless nodes. The first wireless node and the second wireless node periodically exchange a new encryption key whenever a pre-defined time stamp is achieved.

13. The system as recited in claim 12, wherein during the process of exchanging an encryption key, the first wireless node and the second wireless node force and maintain network-based time synchronization between each other to receive the time stamp information.

14. The system as recited in claim 1, wherein the first wireless node and the second wireless node have a signal light to indicate the NODE TYPE of said wireless nodes, depending on the blinking speed of said light.

15. A computer program that is installed in a wireless node to perform the functions, comprising:
a program to receive a BEACON PACKET;
a program to process the BEACON PACKET to extract the CONNECTION PARAMETER;
a program to establish the wireless connection based on the CONENCTION PARAMETER;
a program to allow the first wireless node to connect to the network via the second wireless node;
a program to allow one or more terminals to connect to the network via the first wireless node and the second wireless node.
